(19) United States
(12) Patent Application Publication
(10) Pub. No.: US 2022/0287167 A1
(43) Pub. Date: Sep. 8, 2022

(54) ACOUSTO-OPTIC CONTROL METHOD, SYSTEM, AND AN ACOUSTO-OPTIC DEVICE

(71) Applicant: INTEGRATED INTELLIGENCE TECHNOLOGY (SHENZHEN) LTD., Shenzhen (CN)

(72) Inventor: Yingle WANG, HONG KONG (CN)

(73) Assignee: INTEGRATED INTELLIGENCE TECHNOLOGY (SHENZHEN) LTD., Shenzhen (CN)

(21) Appl. No.: 17/751,672

(22) Filed: May 24, 2022

Related U.S. Application Data
(63) Continuation of application No. PCT/CN2019/124236, filed on Dec. 10, 2019.

(30) Foreign Application Priority Data
Nov. 25, 2019 (CN) 201911167950.2

(51) Int. Cl. H05B 47/12; F21S 4/10

(52) U.S. Cl. CPC H05B 47/12; F21S 4/10

(57) ABSTRACT

The present disclosure provides an acousto-optic control method, a control system thereof, and an acousto-optic device, which can be used to acquire input audio and calculate the spectral energy of the input audio, determine a first light-flickering method corresponding to the spectral energy of the input audio from the flickering method database, and control the lamp beads to work at least according to the first light-flickering method. Thus it is able to repeatedly control the flickering of the lamp beads according to the spectral energy of the sound, so that the sound echoes the light, the fit degree of sound and light is improved, a better lighting atmosphere is created, a more wonderful acousto-optic effect is achieved, and the user experience is thus improved.

### TECHNICAL FIELD

The present disclosure relates to the technical field of light control, and more particularly to an acousto-optic control method, system, and an acousto-optic device.

### BACKGROUND

With the continuous development of light control technology, more and more light control will be combined with sound to give users a better impact visually. At present, most of the ways to control lights via sound are to control lights via predetermined scene modes. However, in the existing light control method, the flickering of the lamp beads can only be controlled according to a predetermined scene mode, which leads to a single style of flickering, a low degree of fit with the sound, and poor user experience. Therefore, it is urgent to provide an acousto-optic control method that can effectively solve the above problems.

### SUMMARY

To overcome the defect of a single style of flickering, a low degree of fit with the sound and poor user experience of the current light control method, the present disclosure provides an acousto-optic control method, system, and an acousto-optic device.

To solve the above technical problems, the present disclosure provides an acousto-optic control method, which includes the following steps:

step S1, acquiring an input audio;

step S2, calculating the spectral energy of the input audio;

step S3, determining a first light-flickering method corresponding to the spectral energy of the input audio from a flickering method database; and

step S4, controlling lamp beads to work at least according to the first light-flickering method.

Preferably, the following steps are further included after the above step S1:

step Sa, dividing the input audio into at least two sub-audio sections according to the frequency;

step S2, calculating the spectral energy of each sub-audio section, and acquiring the spectral energy of the at least two sub-audio sections; and

step S3, determining the first light-flickering method from the flickering method database according to the frequency energy of the at least two sub-audio sections.

Preferably, in step S2, the spectrum energy of the sub-audio is calculated by sampling the sub-audio, acquiring multiple spectrum energy values of each sub-audio section via sampling, and calculating the multiple spectral energy values via weighted average to acquire the spectral energy of the sub-audio;

in step S3, determining the first light-flickering method from the flickering method database according to the frequency energy of the at least two sub-audio sections.

Preferably, the following steps are further included before the above step S1:

step Sb, controlling the lamp beads to work according to a basic light-flickering method; and

the following steps are further included after step S3:

step Sc, superimposing the basic light-flickering method and the first light-flickering method to obtain a target light-flickering method; and

step S4, controlling the lamp beads to work according to the target light-flickering method.

Preferably, the following steps are further included after the above step S4:

step Sd, during the flickering process of the lamp beads, analyzing the rhythm of the input audio, and synchronizing the flickering rhythm of the lamp beads with that of the input audio.

Preferably, the lamp bead has a two-section address code structure; the two-section address code includes a first address code and a second address code; the first address code and the second address code are not the preset value simultaneously; the following steps are further included:

sending a flickering command; the flickering command including a first address value and a second address value; the first address value corresponding to the first address code, and the second address value corresponding to the second address code;

if none of the address values in the flickering command is the preset value, controlling the lamp bead with the address code corresponding to the address value in the flickering command to work;

if any address value in the flickering command is the preset value, controlling the lamp bead with the address code corresponding to the other address value in the flickering command to work;

if the address values in the flickering command are all the preset values, controlling all lamp beads to work.

Preferably, at least two flickering method databases are included; the flickering method databases store at least one light-flickering method, the flickering method databases correspond to frequency, and the light-flickering method corresponds to spectral energy.

Preferably, step S1 specifically includes the following steps:

step S101, receiving a first audio and identifying ambient noise from the first audio;

step S102, generating a counteracting sound wave with an opposite phase and an equal amplitude to that of the ambient noise;

step S103, combining the counteracting sound wave with the first audio to acquire the input audio.

Preferably, the step Sa is specifically dividing the input audio into three sub-audio sections according to the frequencies corresponding to the low frequency, the intermediate frequency, and the high frequency.

To solve the above technical problems, the present disclosure provides another technical solution of an acousto-optic control system, which includes:

a flickering method database, for storing light-flickering method;

an acquiring module, for acquiring input audio;

a calculating module, for calculating the spectral energy of the input audio;

a determining module, for determining a first light-flickering method corresponding to the spectral energy of the input audio from the flickering method database;

a control module, for controlling the lamp beads to work at least according to the first light-flickering method.

Preferably, the acousto-optic control system further includes:

a dividing module, for dividing the input audio into at least two sub-audio sections according to the frequency after the acquiring module acquires the input audio;

the calculating module, further for calculating the spectral energy of each the sub-audio section to acquire the spectral energy;

the determining module, further for determining the first light-flickering method from the flickering method database according to the frequency energy of the at least two sub-audio sections.

Preferably, the control module is further used for controlling the lamp beads to work according to a basic light-flickering method before the acquiring module acquires the input audio;

the acousto-optic control system further includes a superposing module, for superimposing the basic light-flickering method and the first light-flickering method to obtain a target light-flickering method after the determining module determines the first light-flickering method corresponding to the spectral energy of the input audio from the flickering method database;

the control module is further used for controlling the lamp beads to work at least according to the first light-flickering method, which is specifically controlling the lamp beads to work according to the target light-flickering method.

To solve the above technical problems, the present disclosure provides another technical solution of an acousto-optic device, which includes a plurality of lamp beads, a lamp-bead carrier, and an acousto-optic control system, and the lamp beads are arranged on the lamp-bead carrier.

Preferably, the acousto-optic device is a light tree.

Preferably, the acousto-optic device is a Christmas tree.

Compared with the prior art, an acousto-optic control method, a control system thereof and an acousto-optic device of the present disclosure have the following beneficial effects.

The present disclosure provides an acousto-optic control method, which first acquires input audio and calculates the spectral energy of the input audio, then determines a first light-flickering method corresponding to the spectral energy of the input audio from the flickering method database, and controls the lamp beads to work at least according to the first light-flickering method. By the above acousto-optic control method, it is able to repeatedly control the flickering of the lamp beads according to the spectral energy of the sound, so that the sound echoes the light, the fit degree of sound and light is improved, a better lighting atmosphere is created, a more wonderful acousto-optic effect is achieved, and the user experience is thus improved.

In the acousto-optic control method of the present disclosure, after the input audio is acquired, the input audio can be further divided into at least two sub-audio sections according to frequency. Then the spectral energy of each sub-audio section is calculated to acquire the spectral energy of the at least two sub-audio sections. Further, the spectral energy of the at least two sub-audio sections is used to determine the first light-flickering method from the flickering method database. The input audio is divided by the frequency of the sound, so that the determination of the light-flickering method is more accurate, and the flickering effect of the lamp beads is more abundant.

In the acousto-optic control method of the present disclosure, by the method that acquire multiple spectral energy values of each sub-audio section by sampling each sub-audio section, and calculate the spectral energy of the sub-audio via the weighted average of the spectral energy values, the spectral energy can be acquired quickly without complex and time-consuming Fourier transforms. Thus the corresponding lamp bead flickering is acquired quickly, and zero delay is approached.

In this case, the calculation efficiency of audio analysis is improved, the delay is reduced, and the response speed to audio is improved, so that the acousto-optic control method of the present disclosure can respond timely after the input audio is acquired, and user experience is improved. In addition, by searching the first light-flickering method that matches the spectral energy of the at least two sub-audio sections from the light-flickering methods stored in the flickering method database, it can be ensured that the light-flickering methods stored in the flickering method database can be matched with the frequency spectrum of the sub-audio frequency without omission, so that the reliability of the first light-flickering method is improved.

The acousto-optic control method of the present disclosure is first operated according to the basic light-flickering method. After the first light-flickering method is determined, the basic light-flickering method and the first light-flickering method can be further superimposed, so as to obtain a target light-flickering method in which two or more light-flickering methods exist simultaneously, which enriches the flickering effect of the lamp beads.

In the acousto-optic control method of the present disclosure, further, during the flickering process of the lamp beads, the rhythm of the input audio can be analyzed, and then the rhythm of the input audio can be synchronized with the flickering rhythm of the lamp beads. When the rhythm of the sound is fast, the flickering of the lamp beads is accordingly faster; when the rhythm of the sound is slow, the flickering of the lamp beads is accordingly slower, so that the flickering of the lamp beads has a sense of rhythm, and a better acousto-optic interaction effect is achieved.

In the acousto-optic control method of the present disclosure, the lamp bead is a two-section address code structure, which breaks through the one-section address code structure of the traditional lamp bead. The two-section address code can be coordinated in layers to achieve a similar full-point control effect, and the response speed is fast, the delay is reduced, and the response rate of the flickering of the lamp beads is improved.

In the acousto-optic control method of the present disclosure, at least two flickering method databases are included, and the flickering method databases pre-store at least one light-flickering method. The flickering method database corresponds to the frequency, and the light-flickering method corresponds to the spectral energy, so that each sub-audio has its corresponding light-flickering method, which enriches the types of light-flickering methods. The database is first determined by the frequency, and then the flickering method is determined by the energy, that is, the light-flickering method can determine the matching light-flickering method according to different spectral energies in different frequencies of the input audio. Thus the light-flickering method has a higher degree of fit with the input audio, the types of flickering methods are enriched, the user experience is improved and the computing time is reduced.

In the acousto-optic control method of the present disclosure, the purpose of neutralizing the ambient noise is achieved by generating a counteracting sound wave with an opposite phase and an equal amplitude to that of the ambient noise and combining the counteracting sound wave with the first audio. Thus the input audio is acquired, the external ambient noise can be removed, the noise that interferes with the flickering of the light is avoided, and the flickering effect of the light is further improved.

An acousto-optic control system and an acousto-optic device are further provided in the present disclosure, which have the same beneficial effects as the above acousto-optic control method, which will not be repeated here. The acousto-optic device includes a plurality of lamp beads, a lamp-bead carrier, and an acousto-optic control system, and the lamp beads are arranged on the lamp-bead carrier. In addition, the production process of the lamp beads is simple and the variety of colors is rich, which has a great market value.

### BRIEF DESCRIPTION OF THE DRAWINGS

FIG. 1 is a flow diagram 1 of an acousto-optic control method according to a first embodiment of the present disclosure.

FIG. 2 is a flow diagram 2 of the acousto-optic control method according to the first embodiment of the present disclosure.

FIG. 3 is a flow diagram 3 of the acousto-optic control method according to the first embodiment of the present disclosure.

FIG. 4 is a flow diagram 4 of the acousto-optic control method according to the first embodiment of the present disclosure.

FIG. 5 is a flow diagram of a method for acquiring input audio according to the first embodiment of the present disclosure.

FIG. 6 is a first block diagram of functional modules of an acousto-optic control system according to a second embodiment of the present disclosure.

FIG. 7 is a second block diagram of functional modules of the acousto-optic control system according to the second embodiment of the present disclosure.

FIG. 8 is a third block diagram of functional modules of the acousto-optic control system according to the second embodiment of the present disclosure.

FIG. 9 is a block diagram of a structure of an acousto-optic device according to a third embodiment of the present disclosure.

### NUMERICAL REFERENCE IDENTIFICATION

20. acousto-optic control system; 21. flickering method database; 22. acquiring module; 23. calculating module; 24. determining module; 25. control module; 26. dividing module; 27. superposing module; 30. acousto-optic device; 31. lamp bead; 32. lamp-bead carrier; 33. acousto-optic control system.

### DETAILED DESCRIPTION

To make the objectives, technical solutions, and advantages of the present disclosure clearer, the present disclosure is further described in detail below with reference to the accompanying drawings and embodiments. It should be understood that the specific embodiments described herein are provided for illustration only, and not for the purpose of limiting the disclosure.

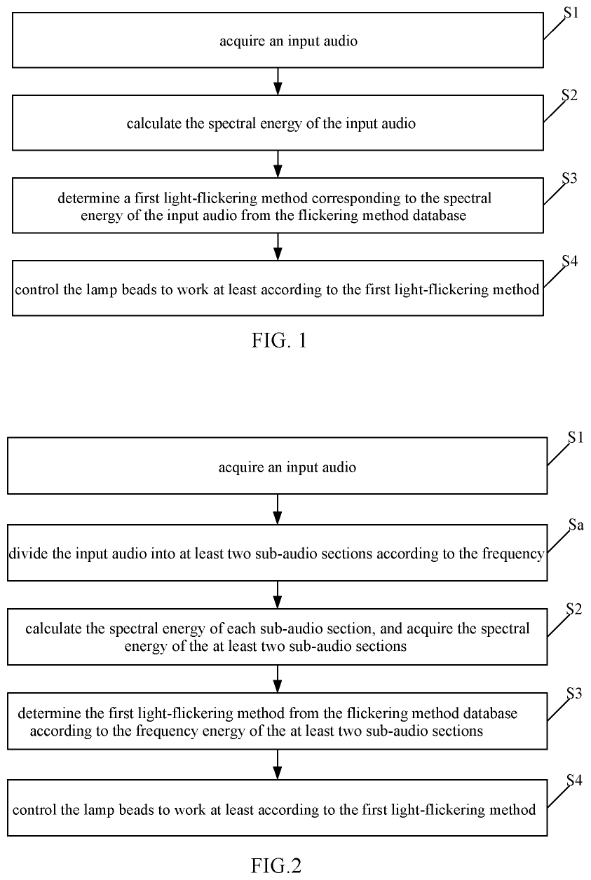

Referring to FIG. 1, a first embodiment of the present disclosure provides an acousto-optical control method, which includes the following steps:

step S1, acquiring an input audio;

step S2, calculating the spectral energy of the input audio;

step S3, determining a first light-flickering method corresponding to the spectral energy of the input audio from the flickering method database; and

step S4, controlling lamp beads to work at least according to the first light-flickering method.

The above acousto-optical control method can achieve the function that the flickering of the lamp beads is controlled according to the spectral energy of the sound, that is, the spectral energy of the sound corresponds with the light-flickering method. Thus the sound echoes the light, the fit degree of sound and light is improved, a better lighting atmosphere is created, a more wonderful acousto-optic effect is achieved, and the user experience is thus improved.

Optionally, the input of the input audio may include but is not limited to line-in, microphone (MIC) input, and Bluetooth input.

Optionally, the light-flickering methods stored in the flickering method database may include but not limited to rain light-flickering method, firework light-flickering method, meteor light-flickering method, flowing-water light-flickering method, and snowflake light-flickering method. The light-flickering methods stored in the flickering method database can use the flickering of lamp beads to simulate a corresponding effect visually. For example, the snowflake light-flickering method can flicker the lamp beads to simulate the effect of fluttering snowflakes, such as controlling the scattered distribution of lamp beads and slowly and intermittently flickering from top to bottom. For example, the flowing-water light-flickering method can flicker the lamp beads to simulate the effect of flowing water, such as controlling part of the lamp beads to light up in a single direction or multiple directions sequentially. It can be understood that the light-flickering methods in the flickering method database are all written in advance and write to the flickering method database. Therefore, the light-flickering methods can be directly read and called when in use.

Optionally, the luminous color of the light in the light-flickering method stored in the flickering method database may include but is not limited to red, green, blue, white, etc., which is not specifically limited in the embodiments of the present disclosure.

Referring to FIG. 2, as an embodiment, the following steps are included after step S1:

step Sa, dividing the input audio into at least two sub-audio sections according to the frequency;

step S2, calculating the spectral energy of each sub-audio section to acquire the spectral energy of the at least two sub-audio sections;

step S3, determining the first light-flickering method from the flickering method database according to the frequency energy of the at least two sub-audio sections.

Based on the above acousto-optic control method, after the input audio is acquired, the input audio can be further divided into at least two sub-audio sections according to frequency. Then the spectral energy of each sub-audio section is calculated to acquire the spectral energy of the at least two sub-audio sections. Further, the spectral energy of the at least two sub-audio sections is used to determine the first light-flickering method from the flickering method database.

As an embodiment, by the frequency of the sound to divide the input audio, the determination of the light-flickering method is more accurate, and the flickering effect of the lamp beads is more abundant. For example, the audio is divided into the low frequency, the intermediate frequency, and the high frequency of three sub-audio sections according to frequency. Specifically, a low-pass filter, a middle-pass filter, and a high-pass filter can be used to divide the input audio into three sub-audio sections according to frequency. Of course, the input audio can also be divided into 4 sections, 5 sections, or more according to the frequency. It can be understood that the input audio may also be divided by time or randomly, and the division rule is not limited.

As an embodiment, in step S2, the calculation method of the spectral energy of the sub-audio is sampling the sub-audio, acquiring multiple spectral energy values of each sub-audio section via sampling, and calculating the spectral energy of the sub-audio via weighted average of the spectral energy values. The input audio is an analog signal, and the sample method is an A/D sample. The sampling time is preferably 120 to 200 times. Further preferably, when the audio is divided into three sub-audio sections according to frequency, for each sub-audio section, sample 30 to 50 times to acquire multiple spectral energy values, and calculate the spectral energy of the sub-audio by weighted average of the spectral energy values.

In step S3, the first light-flickering method that matches the spectral energy of the at least two sub-audio sections is searched out from the light-flickering methods stored in the flickering method database.

In the embodiment of the present disclosure, as an implementation, A/D sampling is a digitization process of a sound signal, of which the main steps include converting a continuously changing analog signal into a discrete digital signal, and using binary numbers to represent the digital signal. It can be understood that, multiple A/D sampling improves the accuracy of the data.

Based on the above acousto-optic control method, by the method that acquire multiple spectral energy values of each sub-audio section via multiple A/D sampling, and calculate the spectral energy of the sub-audio via the weighted average of the spectral energy values, the spectral energy can be acquired quickly without complex and time-consuming Fourier transforms. Thus the corresponding lamp bead flickering is acquired quickly, and zero delay is approached. Therefore, the calculation efficiency of audio analysis is improved, the delay is reduced, and the response speed to audio is improved. As a result, the acousto-optic control method of the present disclosure can respond timely after the input audio is acquired, and user experience is improved. In addition, by searching the first light-flickering method that matches the spectral energy of the at least two sub-audio sections from the light-flickering methods stored in the flickering method database, the light-flickering method can be matched with the spectral energy, the matching of the light and the input audio can be ensured, and a better flickering effect can be achieved.

As an embodiment, the above lamp bead has a two-section address code structure, which includes a first address code and a second address code. The first address code and the second address code of the lamp bead are not the preset value simultaneously. The acousto-optic control method also includes the following steps (not shown):

sending a flickering command; the flickering command including a first address value and a second address value; the first address value corresponding to the first address code, and the second address value corresponding to the second address code;

if none of the address values in the flickering command is the preset value, controlling the lamp bead with the address code corresponding to the address value in the flickering command to work;

if any address value in the flickering command is the preset value, controlling the lamp bead with the address code corresponding to the other address value in the flickering command to work;

if the address values in the flickering command are all the preset values, controlling all lamp beads to work.

In the embodiment of the present disclosure, for example, assuming that the two-section address code has a total of 10 bits, the first section of the address code has 6 bits, and the second section of the address code has 4 bits; the first section of the address value has accordingly 6 bits, and the second section of the address value has accordingly 4 bits; the preset values of the first address value and the second address value are both 0. The first address code and the second address code of the lamp bead are not the preset value, that is, neither the first address code nor the second address code is 0. If both the 6-bit section and the 4-bit section in the sent flickering command are not 0, the lamp beads with the first address code corresponding to the 6-bit section in the flickering command and the second address code corresponding to the 4-bit section in the flickering command are controlled to work. If the 6-bit section in the sent flickering command is 0, the lamp beads with the second address code corresponding to the 4-bit section in the flickering command are controlled to work (the first address code can be any value). If the 4-bit section in the sent flickering command is 0, the lamp beads with the first address code corresponding to the 6-bit section in the flickering command are controlled to work (the second address code can be any value). If the 6-bit section or the 4-bit section in the received flickering command is 0, all lamp beads are controlled to work. It can be understood that the number of digits of the address code can be adjusted as required, and the preset value can also be customized.

The above acousto-optic control method breaks through the one-section address code structure of the traditional lamp bead. The two-section address code can be coordinated in layers to achieve a similar full-point control effect, and the response speed is fast, the delay is reduced, and the response rate of the flickering of the lamp beads is improved.

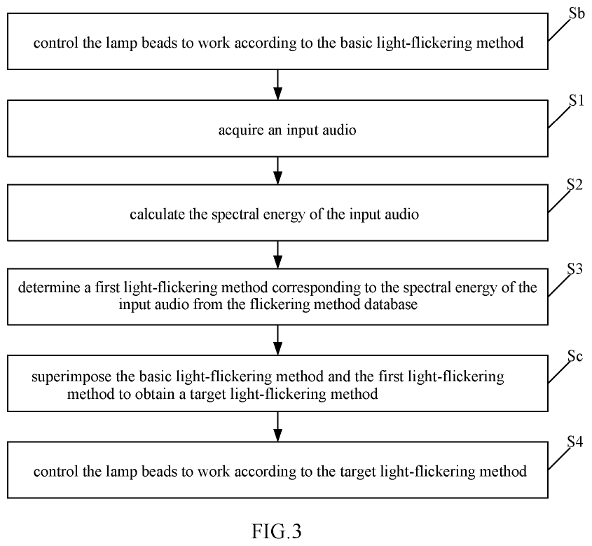

Referring to FIG. 3, as an embodiment, the following steps are further included before step S1:

step Sb, controlling the lamp beads to work according to the basic light-flickering method; and

the following steps are also included after step S3:

step Sc, superimposing the basic light-flickering method and the first light-flickering method to acquire a target light-flickering method; and

step S4, controlling the lamp beads to work according to the target light-flickering method.

Based on the above acousto-optic control method, the lamp beads can be first operated according to the basic light-flickering method, and after the first light-flickering method is determined, the basic light-flickering method and the first light-flickering method can be further superimposed, that is, the first light-flickering method and the basic light-flickering method simultaneously control the light beads in different areas to flicker, so as to obtain a target light-flickering method in which two or more light-flickering methods exist simultaneously, which enriches the flickering effect of the lamp beads.

As an example, there can be multiple basic light-flickering methods, which can be adopted according to user needs instead of a single basic light-flickering method, so that the diversification of the basic light-flickering method is increased, and the user experience is improved.

Optionally, the luminous color of the light in the basic light-flickering methods may include but is not limited to red, green, blue, white, etc., which is not specifically limited in the embodiments of the present disclosure.

As an embodiment, in step Sb, the basic light-flickering method may be selected by the user, and the lamp beads may be controlled to work according to the detected basic light-flickering method selected by the user. Specifically, the method of superimposing the basic light-flickering method and the first light-flickering method to obtain the target light-flickering method can be superimposing the first light-flickering method on the basic light-flickering method, with the basic light-flickering method as the background. For example, assuming that the basic light-flickering method is that the luminous color of all lights is white, the first light-flickering method is the flowing-water light-flickering method and the luminous color is blue. Then, in the embodiment of the present disclosure, part of the lamp beads are controlled to light up sequentially in a single direction or in multiple directions with the white light as the background. In this case, this part of the lamp beads does not work according to the basic light-flickering method, so as to achieve the effect of simulating the flow of flowing water by using lights, and the color corresponding to the “flowing water” is blue. A superimposition method is provided to achieve a visual simulation effect of lights according to the input audio, so that the user can not only feel the auditory experience, but also obtain an intuitive visual effect, thereby improving the auditory experience via the visual effect, and achieving a dual enhancement effect of auditory and visual experience.

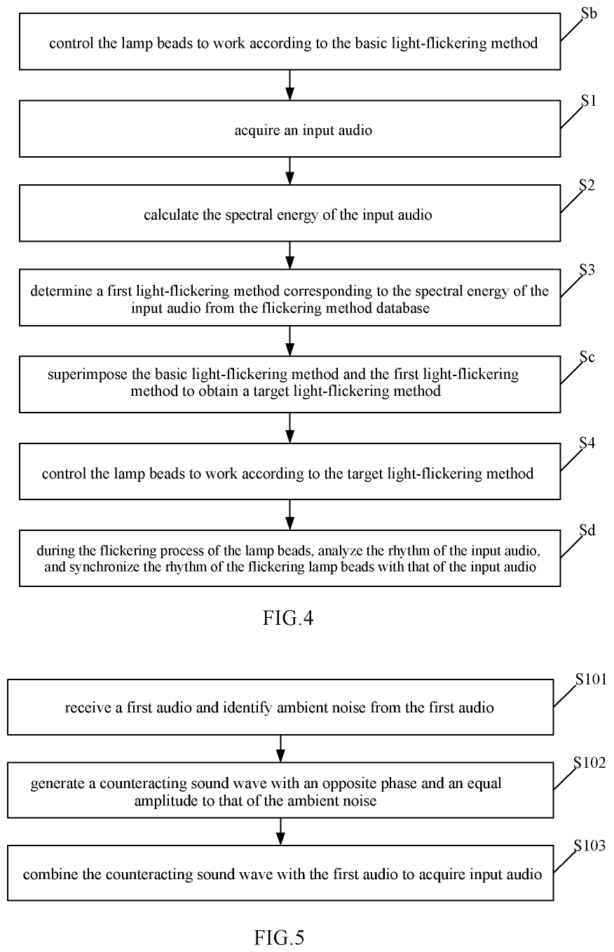

Referring to FIG. 4, as a preferred embodiment, the following steps are included after step S4:

step Sd, during the flickering process of the lamp beads, analyzing the rhythm of the input audio, and synchronizing the flickering rhythm of the lamp beads with that of the input audio.

It can be understood that the rhythm of the sound can be fast or slow, and if the rhythm of the sound is not synchronized with that of the flickering lamp beads, people will have a feeling that the flickering of the lights is very dazzling. Therefore, in the embodiment of the present disclosure, during the flickering process of the lamp beads, the rhythm of the input audio can be analyzed, and then the rhythm of the flickering lamp beads can be synchronized with the rhythm of the input audio. That is, if the rhythm of the sound is fast, the flickering of the lamp beads is accordingly faster; if the rhythm of the sound is slow, the flickering of the lamp beads is accordingly slower, which can make the flickering of the lamp beads more rhythmic and obtain a better acousto-optic interaction effect.

For example, assuming that the basic light-flickering method is that the luminous color of all lights is white, the first light-flickering method is the flowing-water light-flickering method and the luminous color is blue, then, in the embodiment of the present disclosure, part of the lamp beads are controlled to light up sequentially in a single direction or multiple directions with the white light as the background. In this case, this part of the lamp beads does not work according to the basic light-flickering method, so as to achieve the effect of simulating the flow of flowing water by using lights, and the color corresponding to the “flowing water” is blue. When the rhythm of the input audio is faster, the flickering of the lamp beads becomes faster, which is directly reflected in the flow speed of “flowing water”, that is, the flow speed of “flowing water” becomes faster.

Specifically, when analyzing the rhythm of the input audio, the rhythm of the input audio can be divided into three levels of fast, medium and slow, and the rhythm of the flickering lamp beads can accordingly be divided into three levels of fast, medium and slow. When the rhythm of the input audio is analyzed to be fast, the rhythm of controlling the flickering of the lamp beads is fast; when the rhythm of the input audio is analyzed to be medium, the rhythm of controlling the flickering of the lamp beads is medium; when the rhythm of the input audio is analyzed to be slow, the rhythm of controlling the flickering of the lamp beads is slow. It should be noted that the embodiments of the present disclosure do not specifically limit the rhythm division of the input audio and the rhythm division of the flickering lamp beads. Of course, the rhythm of the input audio can also be divided into 4, 5, or more levels, and the flickering rhythm of the lamp beads can also be divided into 4, 5, or more levels accordingly, which can be divided into multiple levels as needed. It can be understood that the more levels the rhythm is divided into, the stronger the sense of rhythm is.

As an embodiment, there are at least two flickering method databases, so that each sub-audio section divided by frequency has its matching flickering method database, and each flickering method database pre-stores at least one light-flickering method. The flickering method database corresponds to frequency, and the light-flickering method corresponds to spectral energy. That is, first a matching flickering method database is determined from at least two flickering method databases according to the frequency. After the flickering method database is determined, since at least one light-flickering method is pre-stored in the flickering method database, the corresponding light-flickering method can be determined from the light-flickering methods stored in the flickering method database according to the spectral energy of the sub-audio. Thus each sub-audio has its corresponding light-flickering method, which enriches the types of light-flickering methods. First, determine the flickering method database by frequency, and then determine the light-flickering method in the corresponding flickering method database by spectral energy. That is, the light-flickering method can determine the matching light-flickering method according to different spectral energies in different frequencies of the input audio, so that the light-flickering method has a higher degree of fit with the input audio, which enriches the types of the flickering methods, improves user experience and reduces computing time.

It can be understood that the more sections the input audio is divided into, the more accurate the matching of the flickering method is, the more abundant the determined light-flickering methods are, and the lower the computation amount is.

It can be noted that, with different frequencies and different spectral energies, the final light-flickering method is accordingly different. Therefore, the above acousto-optic control method can control the flickering of the lamp beads according to the frequency and spectral energy of sound. Thus the sound echoes the light, the fit degree of sound and light is improved, a better lighting atmosphere is created, a more wonderful acousto-optic effect is achieved, and the user experience is thus improved.

Referring to FIG. 5, as an embodiment, step Si specifically includes the following steps:

step S101, receiving a first audio and identifying ambient noise from the first audio;

step S102, generating a counteracting sound wave with an opposite phase and an equal amplitude to that of the ambient noise;

step S103, combining the counteracting sound wave with the first audio to acquire input audio.

It can be understood that, if the input audio contains noise, the noise will affect the light-flickering method to a certain degree, and may even change the light-flickering method. Therefore, to reduce the influence of the ambient noise on the light-flickering method, in the embodiment of the present disclosure, a counteracting sound wave with an opposite phase and an equal amplitude to that of the ambient noise is generated, and the counteracting sound wave is combined with the first audio frequency to neutralize the ambient noise to acquire the input audio. Thus the external ambient noise can be removed, the noise interference with the flickering of the light can be avoided, and the flickering effect of the light can be further improved.

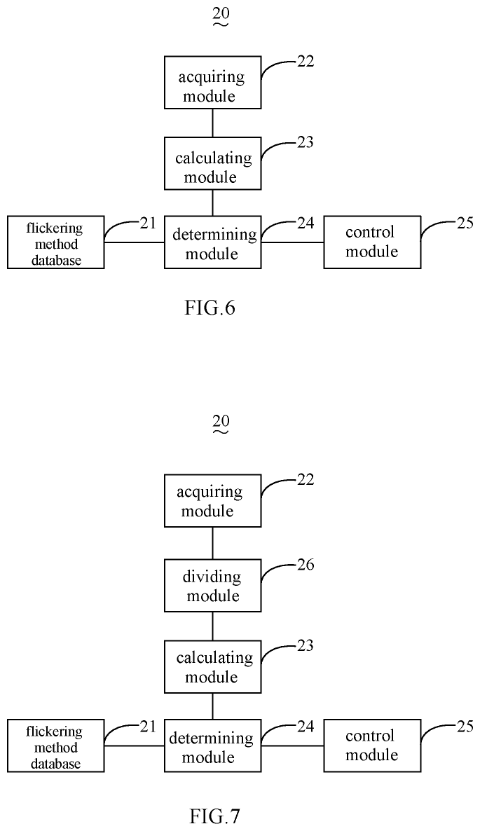

Referring to FIG. 6, a second embodiment of the present disclosure provides an acousto-optic control system 20, which includes:

a flickering method database 21, for storing light-flickering methods;

an acquiring module 22, for acquiring input audio;

a calculating module 23, for calculating the spectral energy of the input audio;

a determining module 24, for determining a first light-flickering method corresponding to the spectral energy of the input audio from the flickering method database;

a control module 25, for controlling the lamp beads to work at least according to the first light-flickering method.

It can be understood that the acousto-optic control system 20 is integrated into one or more chips.

Referring to FIG. 7, as an embodiment, the acousto-optic control system 20 further includes:

a dividing module 26, for dividing the input audio into at least two sub-audio sections according to the frequency after the acquiring module 22 acquires the input audio;

the calculating module 23, further for calculating the spectral energy of each sub-audio to acquire the spectral energy of at least two sub-audios;

the determining module 24, further for determining the first light-flickering method from the flickering method database according to the frequency energy of the at least two sub-audio sections.

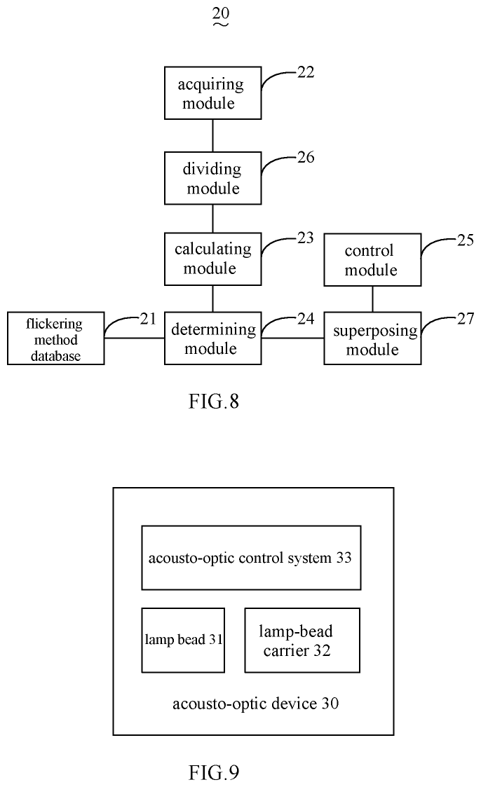

Referring to FIG. 8, as an embodiment, the control module 25 is further used to control the lamp beads to work according to the basic light-flickering method before the acquiring module 22 acquires the input audio.

The acousto-optic control system 20 further includes a superimposing module 27, for superimposing the basic light-flickering method with the first light-flickering method after the determining module 24 determines the first light-flickering method corresponding to the spectral energy of the input audio from the flickering method database, so as to obtain the target light-flickering method.

The control module 25 is further used to control the lamp beads to work according to at least the first light-flickering method, which is specifically controlling the lamp beads to work according to the target light-flickering method.

As an embodiment, the acousto-optic control system 20 further includes the following module which is not shown:

a synchronizing module, for analyzing the rhythm of the input audio during the flickering process of the lamp beads after the control module 25 controls the lamp beads to work according to the target light-flickering method, and synchronizing the flickering rhythm of the lamp beads with the rhythm of the input audio.

Referring to FIG. 9, a third embodiment of the present disclosure provides an acousto-optic device 30. The acousto-optic device 30 may include a plurality of lamp beads 31, a lamp-bead carrier 32, and an acousto-optic control system 33; wherein the lamp beads 31 are arranged on the lamp-bead carrier 32.

Optionally, the arrangement of the lamp beads 31 can be changed according to the lamp-bead carrier 32. For example, in this embodiment, the acousto-optic device 30 may be a light tree, such as a musical Christmas tree. In this case, the lamp-bead carrier 32 is a Christmas tree, and the lamp beads 31 can be arranged around the outline of the Christmas tree, for example, spirally arranged around the periphery of the Christmas tree.

Of course, the above lamp-bead carrier 32 can also be configured as a flat wall, a stage, etc., as long as the lamp beads 31 can be arranged on the light carrier to achieve the acousto-optic control method as described in the first embodiment.

Specifically, the above lamp beads 31 may be traditional in-line type or SMD type LED lamps. In addition, the lamp bead 31 has a simple production process, and produces a variety of designs and colors, and has a great market value.

In the embodiments of the present disclosure, it should be understood that “B corresponding to A” means that B is associated with A, and B can be determined according to A. However, it should also be understood that determining B according to A does not mean that B is only determined according to A, and B may also be determined according to A and/or other information.

It should be understood that “one embodiment” or “an embodiment” throughout the specification means that a particular feature, structure or characteristic associated with the embodiment is included in at least one embodiment of the present disclosure. Thus, “in one embodiment” or “in an embodiment” in various places throughout this specification are not necessarily referring to the same embodiment. Furthermore, the specific features, structures or characteristics may be combined in any suitable method in one or more embodiments. Those skilled in the art should also know that the embodiments described in the specification are all optional embodiments, and the actions and modules involved are not necessarily required by the present disclosure.

In various embodiments of the present disclosure, it should be understood that the sequence of the sequence numbers of the above processes does not imply an inevitable sequence of execution, and the execution sequence of each process should be determined by its functions and inherent logic, and should not constitute any limitation on the implementation process of the embodiments of the present disclosure.

The flowchart and block diagrams in the figures of the present disclosure illustrate the architecture, functionality, and operation of possible implementations of systems, methods and computer program products according to various embodiments of the present disclosure. In this case, each block in the flowchart or block diagrams may represent a module, section, or portion of code that contains one or more executable instructions for implementing the specified logical functions. It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, which is determined based on the functionality involved. It is specifically noted that each block of the block diagrams and/or flowcharts, and combinations of blocks in the block diagrams and/or flowcharts, can be implemented by dedicated hardware-based systems that perform the specified functions or operations, or can be implemented in a combination of dedicated hardware and computer instructions.

Compared with the prior art, the acousto-optic control method, the control system thereof, and the acousto-optic device of the present disclosure have the following beneficial effects.

1. The present disclosure provides an acousto-optic control method, which first acquires input audio and calculates the spectral energy of the input audio, then determines a first light-flickering method corresponding to the spectral energy of the input audio from a flickering method database, and controls the lamp beads to work at least according to the first light-flickering method. By the above acousto-optic control method, it is able to repeatedly control the flickering of the lamp beads according to the spectral energy of the sound, so that the sound echoes the light, the fit degree of sound and light is improved, a better lighting atmosphere is created, a more wonderful acousto-optic effect is achieved, and the user experience is thus improved.

2. In the acousto-optic control method of the present disclosure, after the input audio is acquired, the input audio can be further divided into at least two sub-audio sections according to frequency. Then the spectral energy of each sub-audio section is calculated to acquire the spectral energy of the at least two sub-audio sections. Further, the spectral energy of the at least two sub-audio sections is used to determine the first light-flickering method from the flickering method database. The input audio is divided by the frequency of the sound, so that the determination of the light-flickering method is more accurate, and the flickering effect of the lamp beads is more abundant.

3. In the acousto-optic control method of the present disclosure, by the method that acquire multiple spectral energy values of each sub-audio section by sampling each sub-audio section, and calculate the spectral energy of the sub-audio via the weighted average of the spectral energy values, the spectral energy can be acquired quickly without complex and time-consuming Fourier transforms. Thus the corresponding lamp bead flickering is acquired quickly, and zero delay is approached. In this case, the calculation efficiency of audio analysis is improved, the delay is reduced, and the response speed to audio is improved, so that the acousto-optic control method of the present disclosure can respond timely after the input audio is acquired, and user experience is improved. In addition, by searching the first light-flickering method that matches the spectral energy of the at least two sub-audio sections from the light-flickering methods stored in the flickering method database, it can be ensured that the light-flickering method matches the spectral energy, and the light matches the input audio, so as to obtain a better flickering effect.

4. The acousto-optic control method of the present disclosure is first operated according to the basic light-flickering method. After the first light-flickering method is determined, the basic light-flickering method and the first light-flickering method can be further superimposed, so as to obtain a target light-flickering method in which two or more light-flickering methods exist simultaneously, which enriches the flickering effect of the lamp beads.

5. In the acousto-optic control method of the present disclosure, further, during the flickering process of the lamp beads, the rhythm of the input audio can be analyzed, and then the rhythm of the input audio can be synchronized with the flickering rhythm of the lamp beads. When the rhythm of the sound is fast, the flickering of the lamp beads is accordingly faster; when the rhythm of the sound is slow, the flickering of the lamp beads is accordingly slower, so that the flickering of the lamp beads has a sense of rhythm, and a better acousto-optic interaction effect is achieved.

6. In the acousto-optic control method of the present disclosure, the lamp bead has a two-section address code structure, which breaks through the one-section address code structure of the traditional lamp bead. The two-section address code can be coordinated in layers to achieve a similar full-point control effect, and the response speed is fast, the delay is reduced, and the response rate of the flickering of the lamp bead is improved.

7. In the acousto-optic control method of the present disclosure, at least two flickering method databases are included, and the flickering method database pre-stores at least one light-flickering method. The flickering method database corresponds to the frequency, and the light-flickering method corresponds to the spectral energy, so that each sub-audio has its corresponding light-flickering method, which enriches the types of light-flickering methods. The database is first determined by the frequency, and then the flickering method is determined by the energy, that is, the light-flickering method can determine the matching light-flickering method according to different spectral energies in different frequencies of the input audio. Thus the light-flickering method has a higher degree of fit with the input audio, the types of flickering methods are enriched, the user experience is improved and the computing time is reduced.

8. In the acousto-optic control method of the present disclosure, the purpose of neutralizing the ambient noise is achieved by generating a counteracting sound wave with an opposite phase and an equal amplitude to that of the ambient noise and combining the counteracting sound wave with the first audio. Thus the input audio is acquired, the external ambient noise can be removed, the noise that interferes with the flickering of the light is avoided, and the flickering effect of the light is further improved.

9. An acousto-optic control system and an acousto-optic device are further provided in the present disclosure, which have the same beneficial effects as the above acousto-optic control method, which will not be repeated here. The acousto-optic device includes a plurality of lamp beads, a lamp-bead carrier, and an acousto-optic control system, and the lamp beads are arranged on the lamp-bead carrier. In addition, the production process of the lamp beads is simple and the variety of colors is rich, which has a great market value.

An acousto-optic control method, system, and an acousto-optic device disclosed in the embodiments of the present disclosure have been described in detail above. The principles and implementations of the present disclosure are described with specific embodiments. The descriptions of the above embodiments are only used to help understand the method of the present disclosure and the core idea thereof. At the same time, for those skilled in the art, according to the idea of the present disclosure, there will be changes in the specific embodiments and application scope. In conclusion, the foregoing descriptions should not be construed as as limiting the scope of the disclosure. Any modifications, equivalent replacements and improvements made within the principles of the present disclosure shall be included within the protection scope of the present disclosure.

1. An acousto-optic control method, comprising the following steps:
step S1, acquiring an input audio;
step S2, calculating the spectral energy of the input audio;
step S3, determining a first light-flickering method corresponding to the spectral energy of the input audio from the flickering method database; and
step S4, controlling the lamp beads to work at least according to the first light-flickering method.

2. The acousto-optic control method according to claim 1, further comprising the following steps after step S1:
step Sa, dividing the input audio into at least two sub-audio sections according to the frequency;
step S2, calculating the spectral energy of each sub-audio section to acquire the spectral energy of the at least two sub-audio sections;
step S3, determining the first light-flickering method from the flickering method database according to the frequency energy of the at least two sub-audio sections.

3. The acousto-optic control method according to claim 2, wherein, in step S2, the calculation method of the spectral energy of the sub-audio is sampling the sub-audio, acquiring multiple spectral energy values of each sub-audio section via sampling, and calculating the spectral energy of the sub-audio via weighted average of the spectral energy values;
in step S3, the first light-flickering method that matches the spectral energy of the at least two sub-audio sections being searched out from the light-flickering methods stored in the flickering method database.

4. The acousto-optic control method according to claim 1, further comprising the following steps before step S1:
step Sb, controlling the lamp beads to work according to the basic light-flickering method; and
comprising the following steps after step S3:
step Sc, superimposing the basic light-flickering method and the first light-flickering method to acquire a target light-flickering method; and
step S4, controlling the lamp beads to work according to the target light-flickering method.

5. The acousto-optic control method according to claim 4, further comprising the following steps after step S4:
step Sd, during the flickering process of the lamp beads, analyzing the rhythm of the input audio, and synchronizing the flickering rhythm of the lamp beads with that of the input audio.

6. The acousto-optic control method according to claim 4, wherein the lamp bead has a structure of a two-section address code which comprises a first address code and a second address code that are not the preset value simultaneously; further comprising the following steps:
sending a flickering command, which comprises a first address value and a second address value that respectively corresponds to the first address code and the second address code;
if none of the address values in the flickering command is the preset value, controlling the lamp bead with the address code corresponding to the address value in the flickering command to work;
if any address value in the flickering command is the preset value, controlling the lamp bead with the address code corresponding to the other address value in the flickering command to work;
if the address values in the flickering command are all the preset values, controlling all lamp beads to work.

7. The acousto-optic control method according to claim 2, comprising at least two flickering method databases that store at least one light-flickering method; the flickering method databases corresponding to frequency and the light-flickering method corresponding to spectral energy.

8. The acousto-optic control method according to claim 1, wherein the step S1 specifically comprises the following steps:
step S101, receiving a first audio and identifying ambient noise from the first audio;
step S102, generating a counteracting sound wave with an opposite phase and an equal amplitude to that of the ambient noise;
step S103, combining the counteracting sound wave with the first audio to acquire input audio.

9. The acousto-optic control method according to claim 2, wherein the step Sa is specifically dividing the input audio into three sub-audio sections according to the frequencies corresponding to the low frequency, the intermediate frequency, and the high frequency.

10. An acousto-optic control system, comprising:
a flickering method database, for storing light-flickering methods;
an acquiring module, for acquiring input audio;
a calculating module, for calculating the spectral energy of the input audio;
a determining module, for determining a first light-flickering method corresponding to the spectral energy of the input audio from the flickering method database;
a control module, for controlling the lamp beads to work at least according to the first light-flickering method.

11. The acousto-optic control system according to claim 10, further comprising:
a dividing module, for dividing the input audio into at least two sub-audio sections according to the frequency after the acquiring module acquires the input audio;
the calculating module, further for calculating the spectral energy of each sub-audio to acquire the spectral energy of at least two sub-audios;
the determining module, further for determining the first light-flickering method from the flickering method database according to the frequency energy of the at least two sub-audio sections.

12. The acousto-optic control system according to claim 10, wherein:
the control module is further used for controlling the lamp beads to work according to the basic light-flickering method before the acquiring module acquires the input audio;
the acousto-optic control system further comprising a superposing module, for superimposing the basic light-flickering method and the first light-flickering method to acquire a target light-flickering method after the determining module determines the first light-flickering method corresponding to the spectral energy of the input audio from the flickering method database.
the control module is further used to control the lamp beads to work according to at least the first light-flickering method, which is specifically controlling the lamp beads to work according to the target light-flickering method.

13. An acousto-optic device, comprising a plurality of lamp beads and a lamp-bead carrier and the acousto-optic control system according to claim 10.

14. An acousto-optic device, comprising a plurality of lamp beads and a lamp-bead carrier and the acousto-optic control system according to claim 11.

15. An acousto-optic device, comprising a plurality of lamp beads and a lamp-bead carrier and the acousto-optic control system according to claim 12.

16. An acousto-optic device according to claim 13, wherein the acousto-optic device is a light tree.

17. An acousto-optic device according to claim 13, wherein the acousto-optic device is a Christmas tree.
